(19) United States
(12) Patent Application Publication
(10) Pub. No.: US 2017/0064730 A1
(43) Pub. Date: Mar. 2, 2017

(54) OPTIMIZATION ON USER EQUIPMENT SIDE TO IMPROVE SPECTRAL EFFICIENCY FOR VOICE CALLS IN MOBILE COMMUNICATION DEVICES

(71) Applicant: QUALCOMM Incorporated, San Diego, CA (US)

(72) Inventors: Mukesh Kumar, Dinanagar (IN); Suresh Sanka, Hyderabad (IN); Ravi Kishore Paruchuru, Hyderabad (IN)

(21) Appl. No.: 14/836,756

(22) Filed: Aug. 26, 2015

(51) Int. Cl. H04W 72/12; H04B 17/318; H04L 29/06

(52) U.S. Cl. CPC H04W 72/1263; H04L 65/607; H04B 17/318

(57) ABSTRACT

A method for improving voice calls in a mobile communication device associated with a first radio access technology (RAT) includes: initiating decoding of voice data associated with a dedicated traffic channel (DTCH) associated with the first RAT during a DTCH transmission time interval (TTI); determining whether the decoding of voice data has been completed before the end of the DTCH TTI; and performing signal measurements during a remainder of the DTCH TTI in response to determining that the decoding of voice data has been completed before the end of the DTCH TTI.

### BACKGROUND

During an ongoing voice call using one communication frequency, a mobile communication device periodically measures signal strength of other communication frequencies (i.e., inter-frequency measurements) to support voice call handover and achieve voice continuity in mobility scenarios. Further, multi-subscriber identity module (SIM) multi-standby (MSMS) mobile communication devices may also measure signal strength of one or more inactive radio access technologies (RATs) (i.e., inter-RAT measurements) during an ongoing voice call on the active RAT.

However, the MSMS mobile communication device can only tune to one frequency at a time and therefore cannot perform inter-frequency or inter-RAT measurements during the scheduled transmission time interval (TTI) of the dedicated traffic channel (DTCH) because the Radio Frequency (RF) chain is being utilized by the active voice call.

In order to perform the inter-frequency or inter-RAT measurements, a compressed mode (CM) may be configured by the communication network of the active RAT to provide gaps in the TTIs of the DTCH. However, as the CM is scheduled by the communication network of the active RAT based on the communication network's resources and demands, the CM gaps may not always be time aligned with broadcast windows of the communication network of the inactive RAT.

### SUMMARY

Apparatuses and methods for improving voice calls are provided.

According to various embodiments there is provided a method for improving quality in a voice call in a mobile communication device. In some embodiments, the method may include: initiating decoding of voice data associated with a DTCH associated with the first RAT during a DTCH TTI; determining whether the decoding of voice data has been completed before the end of the DTCH TTI; and performing signal measurements during a remainder of the DTCH TTI in response to determining that the decoding of voice data has been completed before the end of the DTCH TTI.

According to various embodiments there is provided a mobile communication device. In some embodiments, the mobile communication device may include: a communication unit configured for communication with a first communication network using a first RAT; and a control unit. The control unit may be configured to: initiate decoding of voice data associated with a DTCH associated with the first RAT during a DTCH TTI; determine whether the decoding of voice data has been completed before the end of the DTCH TTI; and perform signal measurements during a remainder of the DTCH TTI in response to determining that the decoding of voice data has been completed before the end of the DTCH TTI.

According to various embodiments there is provided a non-transitory computer readable medium. In some embodiments, the non-transitory computer readable medium may include instructions for causing one or more processors to perform operations including: initiating decoding of voice data associated with a DTCH associated with the first RAT during a DTCH TTI; determining whether decoding of voice data has been completed before the end of the DTCH TTI; and performing signal measurements during a remainder of the DTCH TTI in response to determining that the decoding of voice data has been completed before the end of the DTCH TTI.

According to various embodiments there is provided a mobile communication device. In some embodiments, the mobile communication device may include: means for initiating decoding of voice data associated with a dedicated traffic channel (DTCH) associated with a first RAT during a DTCH transmission time interval (TTI); means for determining whether the decoding of voice data has been completed before the end of the DTCH TTI; and means for performing signal measurements during a remainder of the DTCH TTI in response to determining that the decoding of voice data has been completed before the end of the DTCH TTI.

### BRIEF DESCRIPTION OF THE DRAWINGS

Aspects and features of the various embodiments will be more apparent by describing example embodiments with reference to the accompanying drawings, in which:

FIG. 1A is a block diagram illustrating a mobile communication device according to various embodiments;

FIG. 1B is a diagram illustrating a network environment for various embodiments; and

FIG. 2 is a diagram illustrating potential frame early termination (FET) points during a DTCH TTI according to various embodiments;

FIG. 3 is a flowchart illustrating a method for improving voice calls according to various embodiments;

FIG. 4 is a flowchart illustrating a method for improving voice calls according to various embodiments;

FIG. 5 is a sequence diagram illustrating a communication exchange between a communication network and a mobile communication device not requiring a CM according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

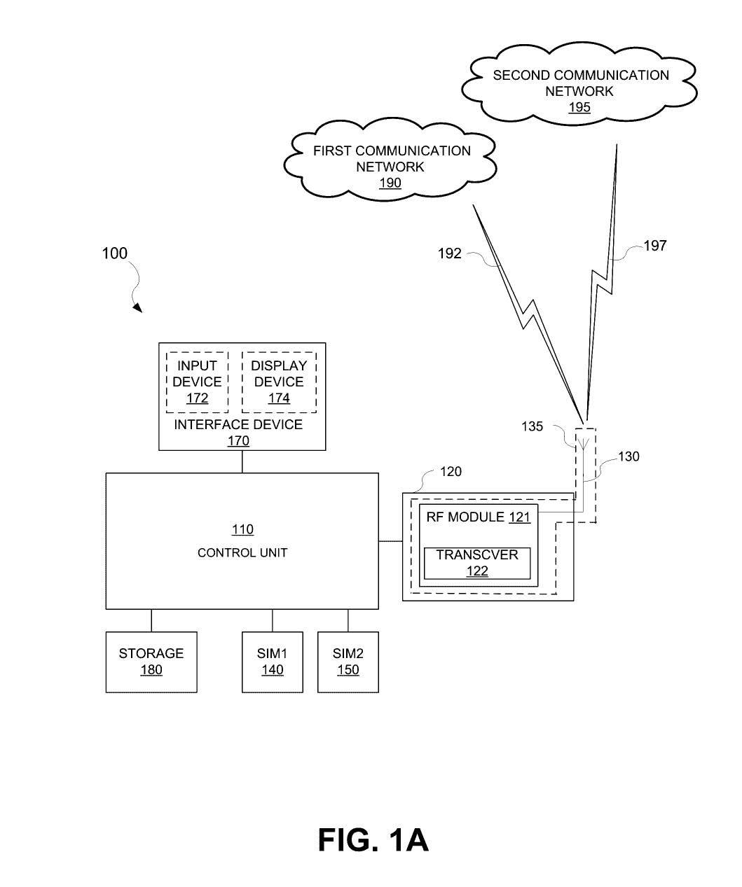

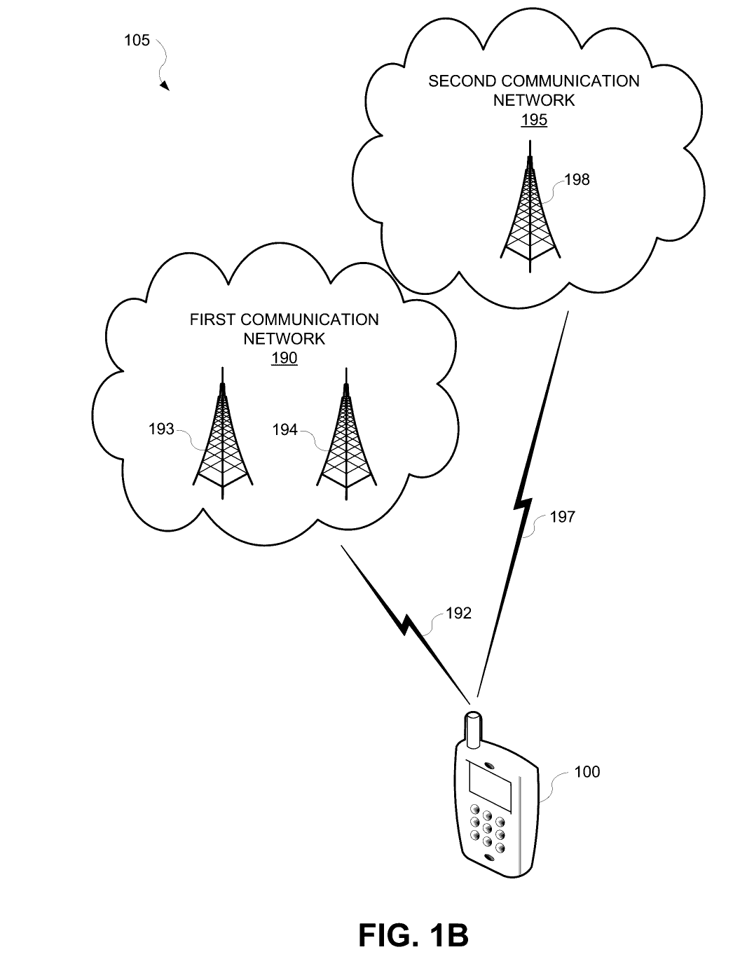

FIG. 1A is a block diagram illustrating a mobile communication device 100 according to various embodiments. As illustrated in FIG. 1A, the mobile communication device 100 may include a control unit 110, a communication unit 120, an antenna 130, a first SIM 140, a second SIM 150, an interface device 170, and a storage 180.

The mobile communication device 100 may be, for example but not limited to, a mobile telephone, smartphone, tablet, computer, etc., capable of communication with one or more wireless networks. One of ordinary skill in the art will appreciate that the mobile communication device 100 may include one or more transceivers (communication units) and may interface with one or more antennas without departing from the scope of various embodiments.

The communication unit 120 may include, for example, but not limited to, one or more radio frequency (RF) modules 121. The RF module 121 may include, for example, but not limited to the first transceiver 122. An RF chain 135 may include, for example, but not limited to the antenna 130 and the RF module 121.

One of ordinary skill in the art will appreciate that embodiments of the mobile communication device 100 may include more than one communication unit and/or more than one antenna without departing from the scope of various embodiments.

A SIM (for example the first SIM 140 and/or the second SIM 150) in various embodiments may be a Universal Integrated Circuit Card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a Code Division Multiple Access (CDMA) network, a SIM may be a UICC removable user identity module (R-UIM) or a CDMA subscriber identity module (CSIM) on a card. A SIM card may have a CPU, ROM. RAM, EEPROM and I/O circuits. An Integrated Circuit Card Identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number/Network Identification Number (NID) pair, a Home PLMN (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various embodiments are described in terms of dual-SIM, dual-standby (DSDS) mobile communication devices. However, one of ordinary skill in the art will appreciate that the various embodiments may be extended to Multi-SIM Multi-Standby (MSMS) and/or Multi-SIM Multi-Active (MSMA) mobile communication devices without departing from the scope of protection. One of ordinary skill in the art will also appreciate that the various embodiments may be extended to a single-SIM mobile communications device

The first communication network 190 and the second communication network 195 may be operated by the same or different service providers, and/or may support the same or different RATs, for example, but not limited to, GSM, CDMA, WCDMA, and Long Term Evolution (LTE).

The interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the interface device 170, and the storage 180. The control unit 110 may be a programmable device, for example, but not limited to, a microprocessor (e.g., general-purpose processor, baseband modem processor, etc.) or microcontroller.

The storage 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of the various embodiments.

The first communication network 190 and the second communication network 195 may implement the same or different RATs. For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, Wideband Code Division Multiple Access (WCDMA), and Time Division-Synchronous Code Division Multiple Access (TD-SCDMA).

The first communication network 190 may include one or more base transceiver stations (BTSs) including, for example, but not limited to, a first BTS 193 and a second BTS 194. The second communication network 195 may also include one or more BTSs, including, for example, but not limited to, a third BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the third BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

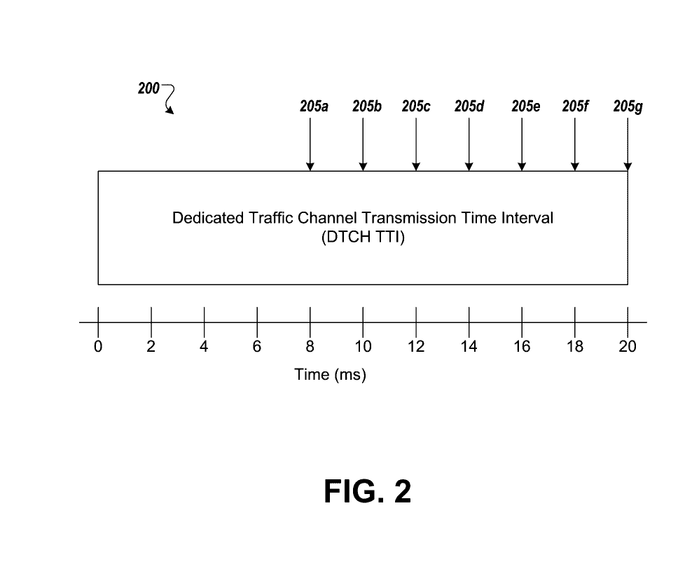

FIG. 2 is a diagram illustrating potential frame early termination (FET) points during a DTCH TTI 200. Referring to FIGS. 1A-2, the DTCH TTI 200 has a duration of twenty milliseconds. However, decoding of the DTCH may be accomplished in less time than allotted for the DTCH TTI 200. For example, a minimum decoding time may be approximately eight milliseconds.

The additional DTCH TTI duration allows redundant decoding of data received during the DTCH TTI 200 if, for example, the mobile communication device 100 and the communication network (e.g., the first communication network 190 and/or the second communication network 195) are not synchronized or the data has not been fully received prior to the start of DTCH TTI 200. However, in many instances, the data received on the DTCH is fully decoded before the end of the DTCH TTI 200. For example, temporal points 205a-205g illustrate potential FET points in which the DTCH may be fully decoded before the end of the DTCH TTI 200.

In some situations, the DTCH may only be partially decoded. For example, during periods of silence on a voice call, data received on the DTCH may be recognizable as indicative of silence based on partial decoding (decoding of a portion of the data). In such a situation, the DTCH decoding may be terminated early (e.g., in less than eight milliseconds of the DTCH TTI 200). Similarly, in some situations the data received on the DTCH may be indicative of a synchronization identification (SID) signal being transmitted from the communication network. The SID signal also may not require full decoding. The data received on the DTCH indicative of a SID signal may be recognized prior to being fully decoded and decoding of the DTCH may be terminated early (i.e., before the end of the DTCH TTI 200).

After decoding has been completed or terminated early, the active RAT may be placed into a sleep mode, and the RF chain 135 may become available for other uses by the mobile communication device 100. In some situations, the RF chain 135 may be available for fifty percent (50%) or more of the DTCH TTI 200. In some embodiments, the RF chain 135 may be used by the active RAT to perform the necessary inter-frequency measurements used to facilitate call hand off from one BTS (e.g., the first BTS 193) to another BTS (e.g., the second BTS 194) of the same communication network (e.g., the first communication network 190). In other embodiments, the RF chain 135 may be used by an inactive RAT (e.g., the RAT associated with the second subscription 197) of the mobile communication device 100 to perform inter-RAT measurements. The inter-RAT measurements may facilitate communications hand off by a BTS on one communication network (e.g., the first BTS 193 on the first communication network 190) to another BTS on another communication network (e.g., the third BTS 198 on the second communication network 195).

The time required to perform either inter-frequency or inter-RAT measurements varies based on characteristics of the communication network (e.g., the first communication network 190 and/or the second communication network 195), the mobile communication device 100, and the RAT involved. However, in many cases the time required to perform either inter-frequency or inter-RAT measurements is three milliseconds or less. Thus, in some situations, the time remaining after the FET (e.g., the time remaining in the DTCH TTI 200 after fully decoding of the DTCH, or the time remaining after terminating the decoding early in response to detecting a SID signal or detecting silence) is sufficient for the inter-frequency or inter-RAT measurements to be made, without requiring CM gaps.

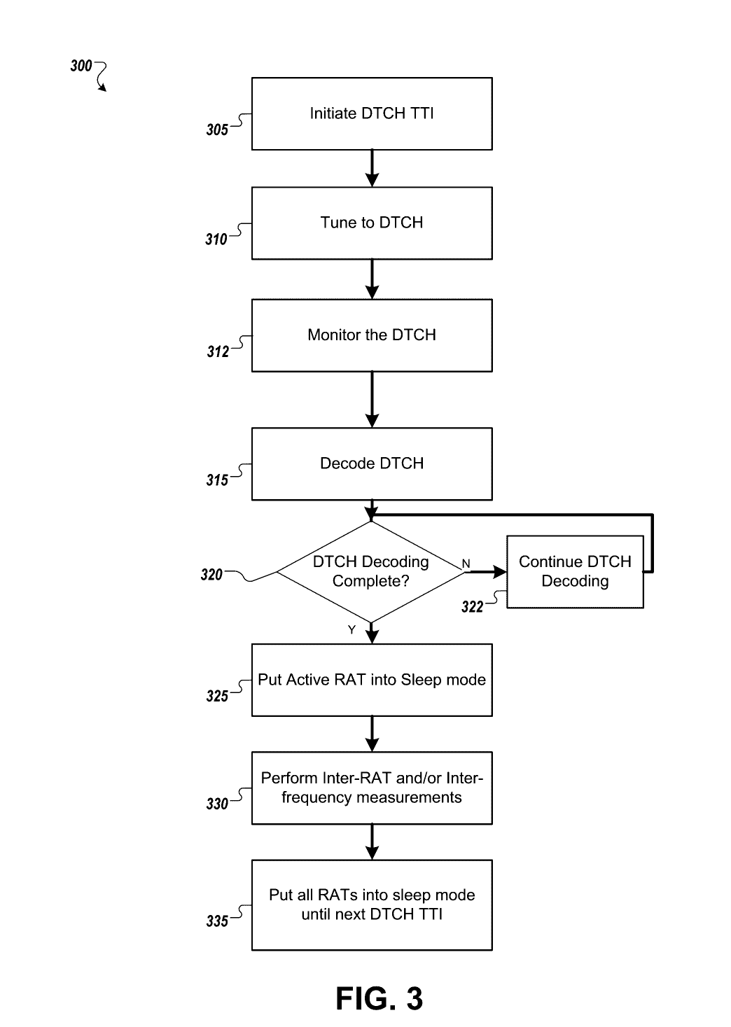

FIG. 3 is a flowchart illustrating a method 300 for improving voice calls according to various embodiments. Referring to FIGS. 1A-3, in order to facilitate and maintain a Release '99 (R99) voice call, the mobile communication device 100 and a BTS (e.g., the first BTS 193) of a communication network (e.g., the first communication network 190) may establish a schedule of DTCH TTIs to allocate a radio channel as the DTCH for an active voice call.

At block 305, the control unit 110 may cause the mobile communication device 100 to initiate the DTCH TTI 200 based on the schedule established between the first BTS 193 and the mobile communication device 100. At block 310, the control unit 110 may cause the communication unit 120 to tune to the DTCH during the DTCH TTI 200. At block 312, the control unit 110 may control the communication unit 120 to monitor the DTCH until data packets are received.

At block 315, the control unit 110 may decode data packets received on the DTCH for the RAT on the active subscription (e.g., SUB1 192) as soon as data packets are received from the first BTS 193. At block 320, the control unit 110 may determine whether the communication unit 120 has completed decoding of the DTCH data packets. If the control unit 110 determines that the communication unit 120 has not completed decoding of the DTCH data packets (i.e., N-320), the control unit 110 may continue to decode data packets received on the DTCH for the RAT on SUB 1 192 at block 322.

Conversely, if the control unit determines that the communication unit 120 has completed decoding (i.e., Y-320), the control unit 110 may control the communication unit 120 to put the RAT on the active subscription (e.g., Sub1 192) into a sleep mode at block 325. For example, after the control unit 110 determines that communication unit 120 has completed decoding of the data packets scheduled for the current DTCH TTI 200, the control unit 110 may put the RAT on the active subscription into sleep mode.

At block 330, the control unit 110 may cause the communication unit 120 to perform either inter-RAT and/or inter-frequency measurements after the RAT on the active subscription (e.g., Sub1 192) has been put into sleep mode. In some embodiments, the control unit 110 may cause the communication unit 120 to take the RAT on the active subscription (e.g., Sub1 192) associated with the on-going voice call out of sleep mode. The control unit 110 may then cause the communication unit 120 to use the RAT on the Sub1 192 to measure signal strength across various frequencies (i.e., inter-frequency measurements) with various BTSs (e.g., the first BTS 193 and the second BTS 194) of the communication network (e.g., the first communication network 190) to determine whether the first BTS 193 or the second BTS 194 should be used to maintain the active call.

Alternatively, in other embodiments, the control unit 110 may cause the communication unit 120 to activate the RAT on the inactive subscription (e.g., Sub2 197) not being used for the voice call. The control unit 110 may then cause the communication unit 120 to use the RAT on Sub2 197 to perform inter-RAT measurements (e.g., signal strength measurements) with at least one BTS (e.g., the third BTS 198) of another communication network (e.g., the second communication network 195) to maintain communication between the mobile communication device 100 and the second communication network 195.

At block 335, the control unit 110 may cause the communication unit 120 to put all of the RATs into sleep mode after the inter-RAT and/or inter-frequency measurements have been completed to conserve power for the remainder of the DTCH TTI 200. The process of 300 may be repeated for every DTCH TTI 200 until the active voice call has ended. In some embodiments, the mobile communication device 100 may also report the inter-RAT and/or inter-frequency measurement results to the BTSs (e.g., the first BTS 193, the second BTS 194, and the third BTS 198) of the communication networks (e.g., the first communication network 190 and the second communication network 195).

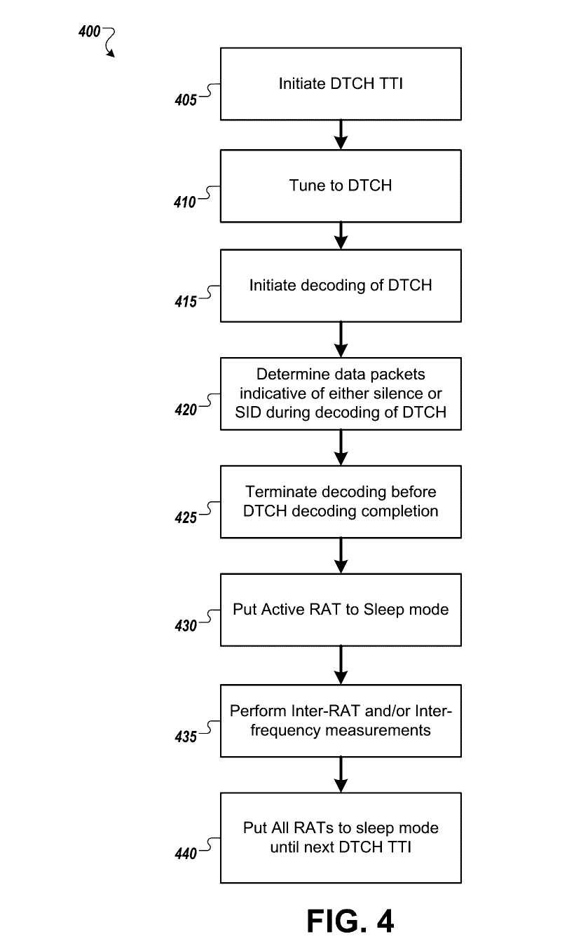

FIG. 4 is flowchart illustrating a method 400 for improving voice calls according to various embodiments. Referring to FIGS. 1A-4, in order to facilitate and maintain an R99 voice call, the mobile communication device 100 and a BTS (e.g., the first BTS 193) of a communication network (e.g., the first communication network 190) may establish a schedule of DTCH TTIs to allocate a radio channel as the DTCH for an active voice call.

At block 405, the control unit 110 may cause the mobile communication device 100 to initiate the DTCH TTI 200 based on the schedule established between the first BTS 193 and the mobile communication device 100. At block 410, the control unit 110 may cause the communication unit 120 to tune to the DTCH during the DTCH TTI 200. At block 415, the control unit 110 may initiate decoding of the DTCH for the RAT on the active subscription (e.g., SUB1 192) as soon as data packets are received from the first BTS 193 on the DTCH.

At block 420, the control unit 110 may monitor the data packets as the data packets are decoded and may determine whether the decoded data packets are indicative of either silence during the voice call, or an SID signal. Data packets indicative of silence or an SID signal may have a consistent pattern and may be distinguishable from voice data, since voice data may vary based on the content of the voice call.

At block 425, the control unit 110 may cause the communication unit 120 to terminate decoding the data packets prior to the completion of decoding the data packets received on the DTCH. For example, after the control unit 110 determines that the decoded data packets are indicative of either silence or an SID signal, the control unit 110 may cause the communication unit 120 to terminate decoding of the data packets. At block 430, the control unit 110 may control the communication unit 120 to put the RAT on the active subscription (e.g., Sub1 192) into a sleep mode when the decoding of the DTCH is terminated before the end of the DTCH TTI 200.

At block 435, the control unit 110 may cause the communication unit 120 to perform either inter-RAT and/or inter-frequency measurements after the RAT on Sub1 192 has been put into sleep mode. In some embodiments, the control unit 110 may cause the communication unit 120 to take the RAT on Sub1 192 associated with the on-going voice call out of sleep mode. The control unit 110 may then cause the communication unit 120 to use the RAT on Sub1 192 to measure signal strength across various frequencies (i.e., inter-frequency measurements) with various BTSs (e.g., the first BTS 193 and the second BTS 194) of the communication network (e.g., the first communication network 190) to determine whether the first BTS 193 or the second BTS 194 should be used to maintain the active call.

Alternatively, in other embodiments, the control unit 110 may cause the communication unit 120 to activate the RAT on the inactive subscription (e.g., Sub2 197) not being used for the voice call. The control unit 110 may then cause the communication unit 120 to use the RAT on Sub2 197 to perform inter-RAT measurements (e.g., signal strength measurements) with at least one BTS (e.g., the third BTS 198) of another communication network (e.g., the second communication network 195) to maintain communication between the mobile communication device 100 and the second communication network 195.

At block 440, the control unit 110 may cause the communication unit 120 to put all of the RATs into sleep mode for the remainder of the DTCH TTI 200 after the inter-RAT and/or inter-frequency measurements have been completed. The process of 400 may be repeated for every DTCH TTI 200 until the active voice call has ended. In some embodiments, the mobile communication device 100 may also report the inter-RAT and/or inter-frequency measurement results to the BTSs (e.g., the first BTS 193, the second BTS 194, and the third BTS 198) of the communication networks (e.g., the first communication network 190 and the second communication network 195).

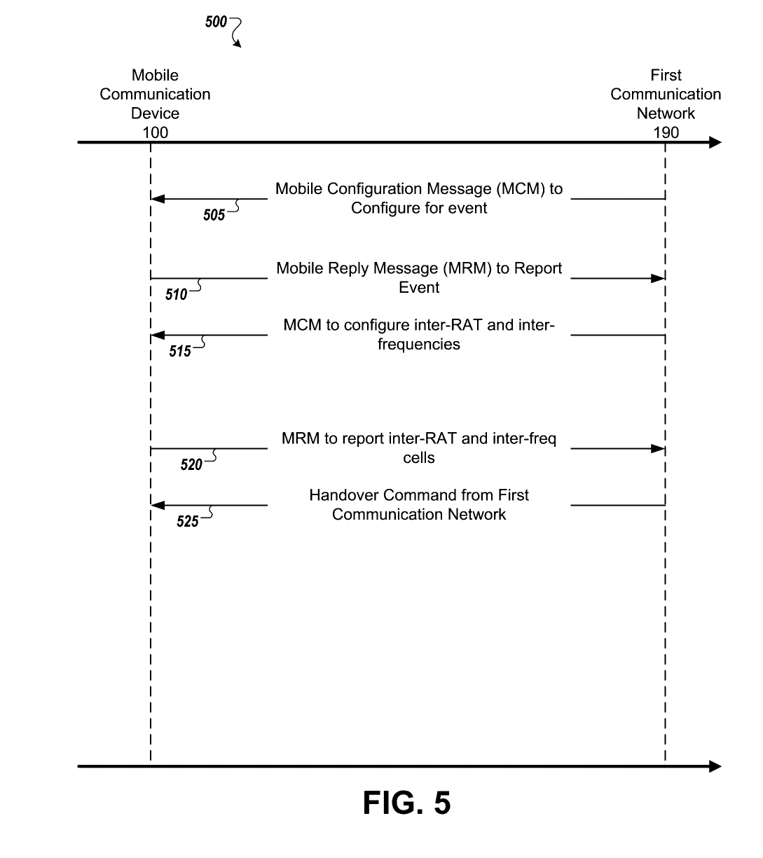

FIG. 5 is a sequence diagram illustrating a communication exchange 500 between a communication network (e.g., the first communication network 190) and the mobile communication device 100 according to various embodiments. With reference to FIGS. 1A-5, at operation 505, the communication exchange 500 may begin with the communication unit 120 of the mobile communication device 100 receiving a mobile configuration message (MCM) from a communication network (e.g., the first communication network 190). For example, the mobile communication device 100 may receive the MCM from a BTS (e.g., the first BTS 193 and/or the second BTS 194) of the first communication network 190. Further, in some embodiments, the mobile communication device may receive a request for confirmation that the mobile communication device 100 is configured and/or capable of determining whether decoding of the voice data has been completed before the end of a DTCH TTI 200. Based on the MCM, the control unit 110 may configure the mobile communication device 100 for a communication event (e.g., a voice call).

At operation 510, the mobile communication device 100 may reply to the MCM with a mobile reply message (MRM) reporting the communication event (e.g., voice call). The MRM may include configuration information indicating capabilities of the mobile communication device 100. For example, the MRM may include information indicating that the mobile communication device 100 has the capability and/or is configured to tune away during a DTCH TTI 200. Thus, the MRM may inform the communication network (e.g., the first communication network 190) that the mobile communication device 100 does not require the CM.

At operation 515, the mobile communication device 100 may receive an MCM from the communication network (e.g., the first communication network 190). The MCM may allow the first communication network 190 to schedule the DTCH TTIs and configure the inter-RAT and inter-frequency measurements by providing scheduling and configuration information to the mobile communication device 100.

Based on the schedule and configuration information provided by the MCM, the mobile communication device 100 may perform inter-RAT and/or inter-frequency measurements during the DTCH TTIs. At operation 520, the control unit 110 may cause the mobile communication device 100 to report inter-RAT and/or inter-frequency measurement results via an MRM message. At operation 525, based on the reported inter-RAT and/or inter-frequency measurements, the mobile communication device 100 may receive a handover command from the communication network (e.g., the first communication network 190) to coordinate handover of the active calls between BTS (e.g., from the first BTS 193 to the second BTS 194) of the first communication network 190.

The methods 300 and 400 may be embodied on a non-transitory computer readable medium, for example, but not limited to, the storage 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to both single-SIM wireless devices as well as multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then.” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for improving a voice call in a mobile communication device associated with a first radio access technology (RAT), the method comprising:
initiating decoding of voice data associated with a dedicated traffic channel (DTCH) associated with the first RAT during a DTCH transmission time interval (TTI);
determining whether the decoding of voice data has been completed before an end of the DTCH TTI; and
performing signal measurements during a remainder of the DTCH TTI in response to determining that the decoding of voice data has been completed before the end of the DTCH TTI.

2. The method of claim 1, wherein the performing signal measurements comprises measuring signal strength of a plurality of communication frequencies between the mobile communication device and a communication network to facilitate inter-frequency handover of the voice call.

3. The method of claim 1, wherein the mobile communication device is associated with both the first RAT and a second RAT; and
wherein the performing signal measurements during the remainder of the DTCH TTI comprises:
switching the first RAT into a sleep mode;
performing signal measurements using the second RAT during the remainder of the DTCH TTI.

4. The method of claim 3, wherein the performing signal measurements comprises measuring signal strength of a plurality of communication frequencies of the second RAT between the mobile communication device and a communication network to facilitate inter-RAT handover of the voice call.

5. The method of claim 1, wherein the determining whether the decoding of voice data has been completed before the end of the DTCH TTI comprises:
decoding a portion of the voice data associated with the DTCH associated with the first RAT;
determining whether the decoded portion of the voice data is indicative of silence during the voice call; and
terminating the decoding of the voice data in response to determining that the decoded portion of the voice data is indicative of silence prior to the voice data being fully decoded.

6. The method of claim 1, wherein the determining whether the decoding of voice data has been completed before the end of the DTCH TTI comprises:
decoding a portion of the voice data associated with the DTCH associated with the first RAT;
determining whether the decoded portion of the voice data is indicative of a synchronization identification (SID) signal received by the mobile communication device; and
terminating the decoding of the voice data in response to determining that the decoded portion of the voice data is indicative of the SID signal received by the mobile communication device prior to the voice data being fully decoded.

7. The method of claim 1, further comprising:
requesting, prior to the initiating the decoding of the voice data, confirmation that the mobile communication device is configured to determine whether the decoding of the voice data has been completed before the end of the DTCH TTI.

8. A mobile communication device comprising:
a communication unit configured for communication with a first communication network using a first radio access technology (RAT); and
a control unit configured to:
initiate decoding of voice data associated with a dedicated traffic channel (DTCH) associated with the first RAT during a DTCH transmission time interval (TTI);
determine whether the decoding of voice data has been completed before an end of the DTCH TTI; and
perform signal measurements during a remainder of the DTCH TTI in response to determining that the decoding of voice data has been completed before the end of the DTCH TTI.

9. The mobile communication device of claim 8, wherein the control unit is configured to perform the signal measurements by measuring signal strength of a plurality of communication frequencies between the communication unit and the first communication network to facilitate inter-frequency handover of a voice call.

10. The mobile communication device of claim 8, wherein the communication unit is configured for communication with the first communication network using the first RAT and communication with a second communication network using a second RAT; and
wherein the control unit is configured to perform the signal measurements during the remainder of the DTCH TTI by:
switching the first RAT into a sleep mode;
performing signal measurements using the second RAT during the remainder of the DTCH TTI.

11. The mobile communication device of claim 10, wherein the control unit is configured to perform the signal measurements by measuring signal strength of a plurality of communication frequencies of the second RAT between the mobile communication device and a communication network to facilitate inter-RAT handover of a voice call.

12. The mobile communication device of claim 8, wherein the control unit is configured to determine whether the decoding of voice data has been completed before the end of the DTCH TTI by:
decoding a portion of the voice data associated with the DTCH associated with the first RAT;
determining whether the decoded portion of the voice data is indicative of silence during a voice call; and
terminating the decoding of the voice data in response to determining that the decoded portion of the voice data is indicative of silence prior to the voice data being fully decoded.

13. The mobile communication device of claim 8, wherein the control unit is configured to determine whether the decoding of voice data has been completed before the end of the DTCH TTI by:
decoding a portion of the voice data associated with the DTCH associated with the first RAT;
determining whether the decoded portion of the voice data is indicative of a synchronization identification (SID) signal received by the mobile communication device; and
terminating the decoding of the voice data in response to determining that the decoded portion of the voice data is indicative of the SID signal received by the mobile communication device prior to the voice data being fully decoded.

14. A non-transitory computer readable medium having stored therein a program for making a computer execute a method for improving a voice call in a mobile communication device associated with a first radio access technology (RAT), said program including computer executable instructions for performing operations comprising:
initiating decoding of voice data associated with a dedicated traffic channel (DTCH) associated with the first RAT during a DTCH transmission time interval (TTI);
determining whether the decoding of voice data has been completed before an end of the DTCH TTI; and
performing signal measurements during a remainder of the DTCH TTI in response to determining that the decoding of voice data has been completed before the end of the DTCH TTI.

15. The non-transitory computer readable medium of claim 14, wherein the performing signal measurements comprises measuring signal strength of a plurality of communication frequencies between the mobile communication device and a communication network to facilitate inter-frequency handover of the voice call.

16. The non-transitory computer readable medium of claim 14, wherein the mobile communication device is associated with both the first RAT and a second RAT; and
wherein the performing signal measurements during the remainder of the DTCH TTI comprises:
switching the first RAT into a sleep mode;
performing signal measurements using the second RAT during the remainder of the DTCH TI.

17. The non-transitory computer readable medium of claim 16, wherein the performing signal measurements comprises measuring signal strength of a plurality of communication frequencies of the second RAT between the mobile communication device and a communication network to facilitate inter-RAT handover of the voice call.

18. The non-transitory computer readable medium of claim 14, wherein the determining whether the decoding of voice data has been completed before the end of the DTCH TTI comprises:
decoding a portion of the voice data associated with the DTCH associated with the first RAT;
determining whether the decoded portion of the voice data is indicative of silence during the voice call; and
terminating the decoding of the voice data in response to determining that the decoded portion of the voice data is indicative of silence prior to the voice data being fully decoded.

19. The non-transitory computer readable medium of claim 14, wherein the determining whether the decoding of voice data has been completed before the end of the DTCH TTI comprises:
decoding a portion of the voice data associated with the DTCH associated with the first RAT;
determining whether the decoded portion of the voice data is indicative of a synchronization identification (SID) signal received by the mobile communication device; and
terminating the decoding of the voice data in response to determining that the decoded portion of the voice data is indicative of the SID signal received by the mobile communication device prior to the voice data being fully decoded.

20. The non-transitory computer readable medium of claim 14, further comprising requesting, prior to the initiating the decoding of the voice data, confirmation that the mobile communication device is configured to determine whether the decoding of the voice data has been completed before the end of the DTCH TTI.

21. A mobile communication device comprising:
means for initiating decoding of voice data associated with a dedicated traffic channel (DTCH) associated with a first RAT during a DTCH transmission time interval (TTI);
means for determining whether the decoding of voice data has been completed before an end of the DTCH TTI; and
means for performing signal measurements during a remainder of the DTCH TTI in response to determining that the decoding has been completed before the end of the DTCH TTI.

22. The mobile communication device of claim 21,
wherein the means for performing signal measurements during the remainder of the DTCH TTI comprises:
means for switching the first RAT into a sleep mode; and
means for performing signal measurements using a second RAT during the remainder of the DTCH TTI.

23. The mobile communication device of claim 21, wherein the means for determining whether the decoding of voice data has been completed before the end of the DTCH TTI comprises:
means for decoding a portion of the voice data associated with the DTCH associated with the first RAT;
means for determining whether the decoded portion of the voice data is indicative of silence during a voice call; and
means for terminating the decoding of the voice data in response to determining that the decoded portion of the voice data is indicative of silence prior to the voice data being fully decoded.

24. The mobile communication device of claim 21, wherein the means for determining whether the decoding of voice data has been completed before the end of the DTCH TTI comprises:
means for decoding a portion of the voice data associated with the DTCH associated with the first RAT;
means for determining whether the decoded portion of the voice data is indicative of an synchronization identification (SID) signal received by the mobile communication device; and
means for terminating the decoding of the voice data in response to determining that the decoded portion of the voice data is indicative of the SID signal received by the mobile communication device prior to the voice data being fully decoded.
